(19) United States
(12) Patent Application Publication
(10) Pub. No.: US 2019/0206610 A1
(43) Pub. Date: Jul. 4, 2019

(54) Stationary Induction Apparatus and Lead Wire Support Device

(71) Applicant: Mitsubishi Electric Corporation, Chiyoda-ku, Tokyo (JP)

(72) Inventors: Yoshinobu KITAGAWA, Tokyo (JP); Takahiko ISHIKURA, Tokyo (JP)

(73) Assignee: Mitsubishi Electric Corporation, Chiyoda-ku, Tokyo (JP)

(21) Appl. No.: 16/322,888

(22) PCT Filed: Aug. 9, 2016
(86) PCT No.: PCT/JP2016/073398

§ 371 Date: Feb. 1, 2019

(51) Int. Cl. H01F 27/28; H01F 27/24

(52) U.S. Cl. CPC H01F 27/2828; H01F 27/24

(57) ABSTRACT

A lead wire support device is made of an insulator, and supports a lead wire drawn out from a winding of a stationary induction apparatus. The lead wire support device is fixed to an inner wall of a tank. A creepage path from the lead wire to the inner wall includes a first point and a second point. The first point is a point at which a creepage distance from the lead wire is a first distance. The second point is a point at which the creepage distance from the lead wire is a second distance longer than the first distance. A potential at the second point is higher than a potential at the first point.

### TECHNICAL FIELD

The present invention relates to a stationary induction apparatus and a lead wire support device.

### BACKGROUND ART

Japanese Patent Laying-Open No. 2012-199307 (PTL 1) is a prior art document that discloses a lead wire support device for supporting a lead wire drawn out from a coil of a stationary induction apparatus. The lead wire support device described in PTL 1 includes a cylindrical lead wire support. This lead wire support supports the lead wire at a prescribed distance from a wall portion of a tank. An insulation distance between the lead wire and the wall portion of the tank is thus ensured.

The lead wire support described above is formed by a combination of a plurality of pressboard laminates. Each of the pressboard laminates includes a plurality of laminated pressboards and forms an arc shape in cross section. An inner circumferential surface of each of the plurality of pressboard laminates is in close contact with an outer circumferential surface of the lead wire. Pressboard laminates adjacent to each other of the plurality of pressboard laminates are butted and fixed together at their circumferential ends.

### CITATION LIST

### Patent Literature

PTL 1: Japanese Patent Laying-Open No. 2012-199307

### SUMMARY OF INVENTION

### Technical Problem

The lead wire support device described in PTL 1 suppresses the occurrence of an electric discharge at a partial bond failure such as air bubbles present at a bond interface between the pressboards due to an electric field generated around the lead wire.

In a stationary induction apparatus, on the other hand, when a voltage applied to the lead wire is very high, a creeping discharge may occur between the lead wire and the tank through the lead wire support device due to insufficient insulation performance of the lead wire support device.

To suppress the occurrence of the creeping discharge, it is effective to increase a creepage length of the lead wire support device. The increased creepage length, however, causes problems such as increased size and weight of the lead wire support device. It is feared that the increased size and weight of the lead wire support device will result in increased size and weight of the stationary induction apparatus. It is also feared that the workability of arranging the lead wire within the tank will be reduced.

The present invention has been made to solve the above problem, and has an object to provide a stationary induction apparatus and a lead wire support device capable of suppressing a creeping discharge while having a small and lightweight configuration.

### Solution To Problem

A stationary induction apparatus according to one aspect of the present invention includes a core, a winding, a tank, and a lead wire support device. The winding is wound around the core. The tank contains the core and the winding. The lead wire support device is made of an insulator, and supports a lead wire drawn out from the winding. The lead wire support device is fixed to an inner wall of the tank. A creepage path from the lead wire to the inner wall includes a first point and a second point. The first point is a point at which a creepage distance from the lead wire is a first distance. The second point is a point at which the creepage distance from the lead wire is a second distance longer than the first distance. A potential at the second point is higher than a potential at the first point.

A lead wire support device according to another aspect of the present invention is configured to fix a lead wire of a winding contained in a tank to an inner wall of the tank. In the lead wire support device, a creepage path from the lead wire to the inner wall includes a first point and a second point. The first point is a point at which a creepage distance from the lead wire is a first distance. The second point is a point at which the creepage distance from the lead wire is a second distance longer than the first distance. A potential at the second point is higher than a potential at the first point.

### Advantageous Effects of Invention

According to the present invention, a stationary induction apparatus and a lead wire support device capable of suppressing a creeping discharge while having a small and lightweight configuration can be provided.

### BRIEF DESCRIPTION OF DRAWINGS

FIG. 1 is a sectional view showing the configuration of a stationary induction apparatus according to a first embodiment of the present invention.

FIG. 2 is a partial sectional view of the stationary induction apparatus of FIG. 1, taken along the line II-II in a direction of arrows.

FIG. 3 is a partial sectional view illustrating a creeping discharge between a lead wire and a tank.

FIG. 4 schematically shows electric field analysis results when an AC current is flowing in the lead wire.

FIG. 5 schematically shows electric field analysis results when a DC current is flowing in the lead wire.

FIG. 6 is a graph showing relation between a creepage distance from the lead wire and potential.

FIG. 7 is a sectional view showing the configuration of a stationary induction apparatus according to a second embodiment of the present invention.

FIG. 8 is a sectional view of the stationary induction apparatus of FIG. 7, taken along the line VIII-VIII in a direction of arrows.

FIG. 9 is an external perspective view illustrating an arrangement structure of lead wire support devices according to a third embodiment.

### DESCRIPTION OF EMBODIMENTS

Embodiments of the present invention will be described below in detail with reference to the drawings. The same or corresponding parts in the drawings are designated by the same characters and will not be described repeatedly. Examples of a stationary induction apparatus include a transformer, a reactor and the like.

### First Embodiment

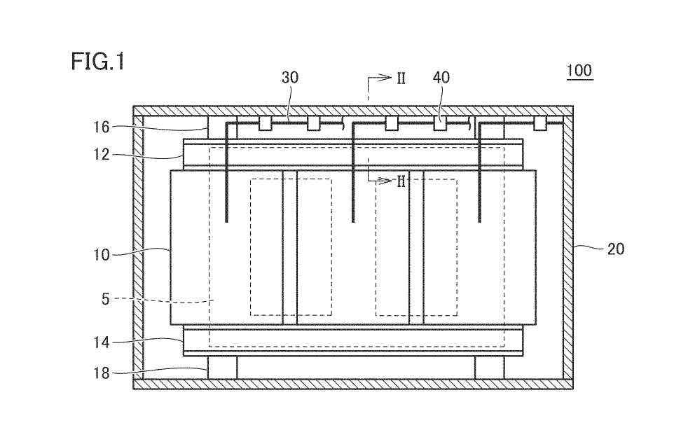

FIG. 1 is a sectional view showing the configuration of a stationary induction apparatus according to a first embodiment of the present invention. Referring to FIG. 1, a stationary induction apparatus 100 according to the first embodiment includes a core 5, a winding 10 wound around core 5, a tank 20 containing core 5 and winding 10, and a lead wire support device 40.

Core 5 is formed of a plurality of laminated magnetic steel plates. Core 5 has three legs. Winding 10 is wound around each leg of core 5.

Winding 10 includes low-voltage windings wound around the legs of core 5, and high-voltage windings located on the outer side of the low-voltage windings and wound around the legs of core 5. Stationary induction apparatus 100 is a so-called core-type transformer. Each of the low-voltage windings and the high-voltage windings includes a conductor made of copper, and an insulating paper wound around the conductor. The conductor is insulation-coated by the insulating paper.

Core 5 and three windings 10 are sandwiched and fixed between a first end frame 12 and a second end frame 14. Specifically, each of first end frame 12 and second end frame 14 is formed of a pair of frame members. An end portion of core 5 which is located on one side in an axial direction of windings 10 is sandwiched and fixed between the pair of frame members forming first end frame 12. An end portion of core 5 which is located on the other side in the axial direction of windings 10 is sandwiched and fixed between the pair of frame members forming second end frame 14.

Each of three windings 10 is sandwiched and fixed between first end frame 12 and second end frame 14, so as to be pushed by first end frame 12 from the one side in the axial direction of winding 10, and pushed by second end frame 14 from the other side in the axial direction of winding 10.

First end frame 12 is coupled to a first support plate 16. First support plate 16 is connected to an inner wall on the ceiling side of tank 20. Second end frame 14 is coupled to a second support plate 18. Second support plate 18 is connected to an inner wall on the floor side of tank 20. First support plate 16 and second support plate 18 prevent horizontal displacement of core 5 and winding 10.

Tank 20 is filled with an insulating medium. The insulating medium is an insulating oil or an insulating gas. A mineral oil, an ester oil or a silicon oil is used, for example, as the insulating oil. An SF₆ gas or dry air is used, for example, as the insulating gas.

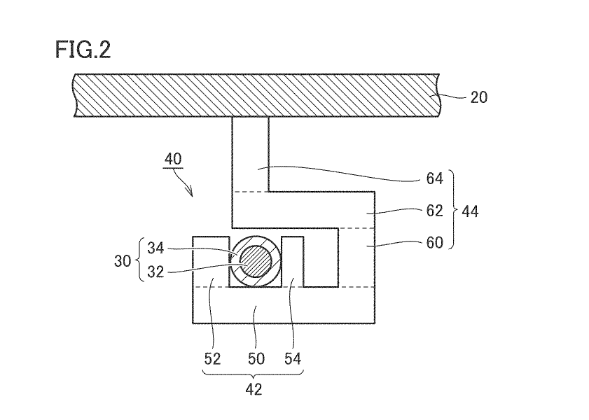

Lead wire support device 40 supports a lead wire 30 drawn out from winding 10. Lead wire support device 40 is fixed to the inner wall of tank 20. The configuration of lead wire support device 40 is described using FIG. 2.

FIG. 2 is a partial sectional view of the stationary induction apparatus of FIG. 1, taken along the line II-II in a direction of arrows. Referring to FIG. 2, lead wire support device 40 is fixed to the inner wall on the ceiling side of tank 20. Lead wire support device 40 is configured to support lead wire 30 drawn out from winding 10 toward the ceiling of tank 20. Lead wire 30 includes a conductor 32, and an insulating paper 34 which insulation-coats conductor 32.

Specifically, lead wire support device 40 includes a sandwiching and holding portion 42 to sandwich and hold lead wire 30, and a fixing portion 44 to fix sandwiching and holding portion 42 to the inner wall of tank 20. Each of sandwiching and holding portion 42 and fixing portion 44 is made of an insulator. Pieces of wood laminated via an adhesive layer is used, for example, for each of sandwiching and holding portion 42 and fixing portion 44.

Sandwiching and holding portion 42 includes a base portion 50 and two protrusions 52, 54. Base portion 50 includes a first main surface facing the inner wall on the ceiling side of tank 20, and a second main surface located opposite to the first main surface. Protrusions 52 and 54 are disposed on the first main surface of base portion 50. Each protrusion has a shape protruding toward the ceiling of tank 20.

Lead wire 30 is located on the first main surface of base portion 50 so as to be sandwiched between two protrusions 52 and 54. Lead wire 30 is in direct contact with sandwiching and holding portion 42, and is fixed to sandwiching and holding portion 42 under its own weight. Lead wire 30 may be fixed by taping lead wire 30 and sandwiching and holding portion 42 together with an insulating tape. Lead wire 30 is sandwiched and held by sandwiching and holding portion 42 in this manner.

Fixing portion 44 has a first member 60, a second member 62, and a third member 64. First member 60 has one end connected to base portion 50, and the other end connected to second member 62. Third member 64 has one end connected to the inner wall of tank 20, and the other end connected to second member 62. Second member 62 is disposed to face base portion 50. First member 60 is disposed to stand from second member 62 toward the ceiling of tank 20. Third member 64 is disposed to stand from second member 62 toward the floor of tank 20.

As shown in FIG. 2, lead wire 30 is supported by lead wire support device 40 at a plurality of locations within tank 20. A prescribed insulation distance is ensured between lead wire 30 and tank 20 by lead wire support device 40.

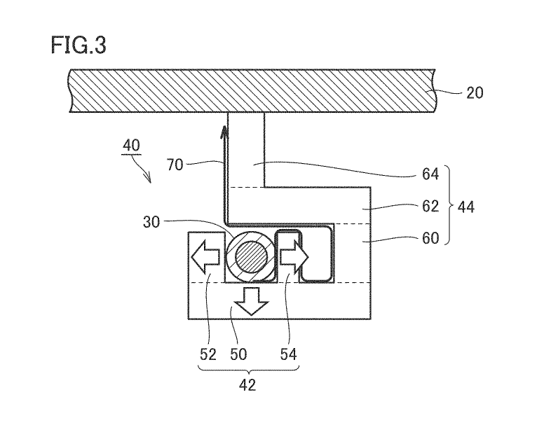

When a current flows in lead wire 30 in such a state, an electric field is generated around lead wire 30, as indicated by white arrows in FIG. 3. Assuming that the strength of the electric field at a point P at a spatial distance of r from lead wire 30 is E, the value of E is expressed by an equation (1). Assuming that a potential at point P is ϕ, the value of ϕ is expressed by an equation (2). Q represents an electric charge of lead wire 30, and ϵ represents a dielectric constant of the insulating medium filling tank 20 and/or of lead wire support device 40.

E=q/4πϵ·1/r² (1)

Φ=q/4πϵ·1/r (2)

As can be understood from the equation (1), the strength of the electric field generated from lead wire 30 decreases with increase in the spatial distance from lead wire 30. As used herein, the spatial distance from lead wire 30 refers to a linear distance between lead wire 30 and a certain point P. In contrast, a creepage distance from lead wire 30 refers to a distance measured along the surface of an insulator located between lead wire 30 and certain point P. This insulator is primarily lead wire support device 40.

When a voltage applied to lead wire 30 is high, the strength of the electric field generated from lead wire 30 increases, which may cause a creeping discharge to occur between lead wire 30 and tank 20. A creeping discharge is a phenomenon where an electric discharge progresses from a high potential area to a low potential area along the surface of an insulator. When a creeping discharge occurs between lead wire 30 and tank 20, therefore, the creeping discharge progresses from lead wire 30 toward tank 20 along a creepage path 70 formed on the surface of lead wire support device 40, as shown in FIG. 3.

To suppress the creeping discharge that occurs between lead wire 30 and tank 20, it is effective to increase the creepage distance between lead wire 30 and tank 20. To do so, the creepage length of lead wire support device 40 needs to be increased. To increase the creepage length of lead wire support device 40, the length of fixing portion 44 will be primarily increased, causing fixing portion 44 to be routed within tank 20.

The increased creepage length of lead wire support device 40 as described above, however, causes lead wire support device 40 to increase in size and weight. It is feared that stationary induction apparatus 100 will thereby also increase in size and weight. It is also feared that the workability of arranging lead wire 30 within tank 20 will be reduced.

In lead wire support device 40 according to the first embodiment, therefore, creepage path 70 from lead wire 30 to the inner wall of tank 20 is provided with a section in which the progress of a creeping discharge can be hindered. This section is configured such that the potential increases with increase in the creepage distance from lead wire 30. That is, in this section, the direction of an electric field is opposite to the direction of progress of a creeping discharge. In this section, therefore, the creeping discharge is forced to travel from a low potential area to a high potential area. As a result, the progress of the creeping discharge is hindered.

More specifically, the above-described section is provided in fixing portion 44 in the first embodiment. In the example of FIGS. 2 and 3, the above-described section is implemented by second member 62 of fixing portion 44. Accordingly, there is no need to route fixing portion 44 due to the increased creepage length of lead wire support device 40, so that lead wire support device 40 can have a compact shape. Thus, lead wire support device 40 can be prevented from increasing in size and weight. As a result, stationary induction apparatus 100 can also be prevented from increasing in size and weight. In addition, the workability of arranging lead wire 30 can be improved.

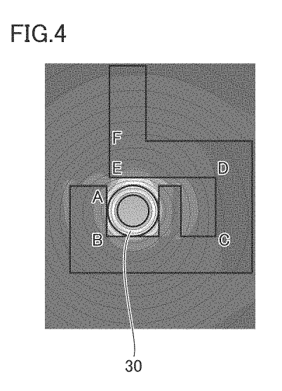

Referring now to FIGS. 4 to 6, relation between the creepage distance from lead wire 30 and the potential in lead wire support device 40 according to the first embodiment is described.

FIG. 4 schematically shows electric field analysis results when an AC current is flowing in lead wire 30. FIG. 4 shows results of simulation of potential distribution generated around lead wire 30. FIG. 4 shows a plurality of equipotential lines formed concentrically around lead wire 30. Of the plurality of equipotential lines, an equipotential line at the shortest spatial distance from lead wire 30 has the highest potential, with the potentials of the equipotential lines decreasing with increase in the spatial distance from lead wire 30.

Here, as shown in FIG. 4, a plurality of points A to F are set on the creepage path of lead wire support device 40. The plurality of points A to F are at different creepage distances from lead wire 30 from one another. A creepage distance from lead wire 30 to a certain point refers to a distance between lead wire 30 and the certain point measured along the surface of lead wire support device 40.

In FIG. 4, points A and B are located at protrusion 52, point C is located at first member 60, points D and E are located at second member 62, and point F is located at third member 64. Points A to F are at successively increasing creepage distances from lead wire 30. When a creeping discharge occurs between lead wire 30 and tank 20, therefore, the creeping discharge will progress from lead wire 30 toward tank 20 by successively passing through point A, point B, point C, point D, point E and point F.

Furthermore, in FIG. 4, points A to F are at nonuniform spatial distances from lead wire 30. Thus, the potentials at points A to F are also nonuniform. More particularly, point A, point B and point E are at shorter spatial distances from lead wire 30 than point C, point D and point F. Thus, the potentials at point A, point B and point E are higher than the potentials at point C, point D and point F.

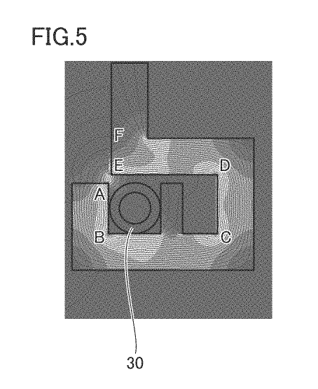

FIG. 5 schematically shows electric field analysis results when a DC current is flowing in lead wire 30. FIG. 5 shows results of simulation of potential distribution generated around lead wire 30. As in FIG. 4, FIG. 5 shows a plurality of equipotential lines formed around lead wire 30.

When a DC current is flowing in lead wire 30, the potential distribution depends on the difference in resistance value between lead wire support device 40 and the insulating medium. In FIG. 5, since there is a tenfold or more difference in resistance value between them, the electric field is concentrated on lead wire support device 40. Accordingly, the plurality of equipotential lines are not concentric. In contrast, when an AC current is flowing in lead wire 30, the potential distribution depends less on the difference in resistance value between lead wire support device 40 and the insulating medium, and depends mainly on the difference in dielectric constant between them. In FIG. 4, since the difference in dielectric constant between them is as small as about twofold to threefold, the plurality of equipotential lines are concentric without being influenced by the difference in dielectric constant. As in FIG. 4, the plurality of points A to F are set on the creepage path of lead wire support device 40 in FIG. 5.

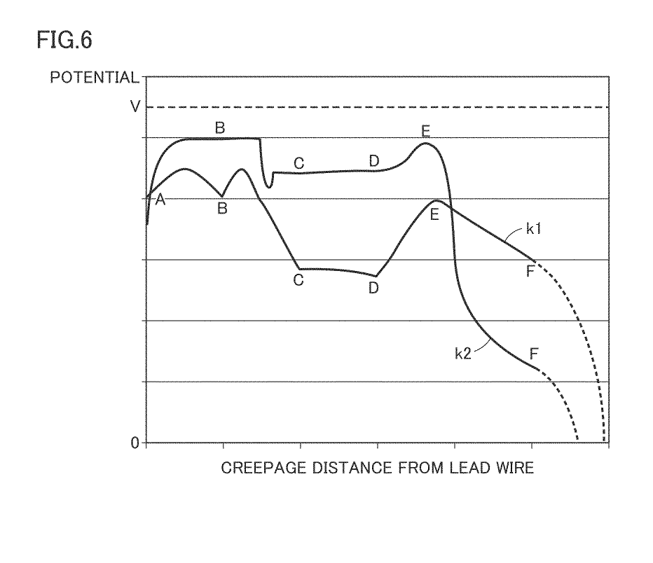

FIG. 6 graphically shows relation between the creepage distance from lead wire 30 and the potential in the potential distributions shown in FIGS. 4 and 5. Referring to FIG. 6, the horizontal axis represents the creepage distance from lead wire 30, and the vertical axis represents the potential. In the vertical axis, a potential V indicates a potential at the surface of lead wire 30, and a potential 0 (ground potential) indicates a potential at tank 20.

A line k1 in the figure shows relation between the creepage distance from lead wire 30 and the potential based on the potential distribution shown in FIG. 4. A line k2 in the figure shows relation between the creepage distance from lead wire 30 and the potential based on the potential distribution shown in FIG. 5. Characters A to F attached to each line correspond to the plurality of points A to F set in FIGS. 4 and 5, respectively. For example, C in FIG. 6 corresponds to point C in FIGS. 4 and 5, and represents a potential at point C.

As shown in FIG. 6, lines k1 and k2 are similar in how the potential varies, although they differ in magnitude of the potential at each point. More particularly, the potential is lower at point C and point D than at point B, but then starts to increase from point D toward point E. The potential then decreases again after peaking at point E.

Here, looking at point D and point E, point E is at a longer creepage distance from lead wire 30 than point D. On the other hand, point E is at a shorter spatial distance from lead wire 30 than point D. Thus, the potential at point E is higher than the potential at point D. Accordingly, in a section from point D to point E (which corresponds to second member 62), the potential increases with increase in the creepage distance from lead wire 30. In the section from point D to point E, therefore, a creeping discharge is forced to travel from a low potential area to a high potential area. As a result, the progress of the creeping discharge is hindered. In this manner, the section from point D to point E implements a section for hindering the progress of a creeping discharge.

As described above, in accordance with lead wire support device 40 according to the first embodiment, the creepage path from lead wire 30 to tank 20 is provided with the section in which an electric field is generated in a direction opposite to the direction of progress of a creeping discharge, so that the creeping discharge can be hindered from progressing along this creepage path.

Furthermore, in accordance with the lead wire support device according to the first embodiment, there is no need to increase the creepage length of the lead wire support device, so that the lead wire support device can have a compact shape. Accordingly, the lead wire support device can be prevented from increasing in size and weight. Thus, the stationary induction apparatus can be prevented from increasing in size and weight, and the workability of arranging the lead wire is improved.

### Second Embodiment

A variation of lead wire support device 40 is described in a second embodiment.

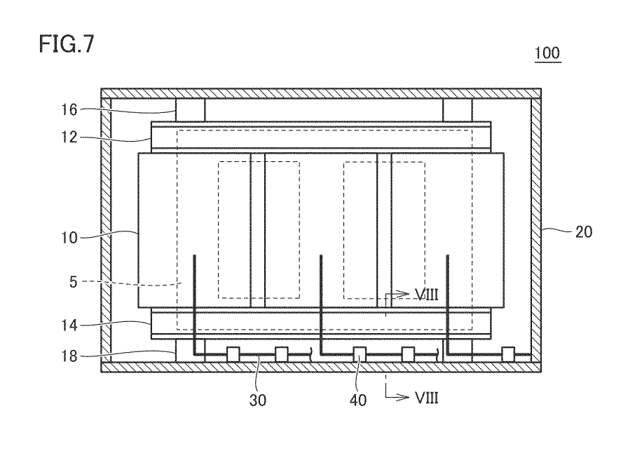

FIG. 7 is a sectional view showing the configuration of a stationary induction apparatus according to the second embodiment of the present invention. Stationary induction apparatus 100 according to the second embodiment is configured in a manner similar to stationary induction apparatus 100 according to the first embodiment (FIG. 1). In stationary induction apparatus 100 according to the second embodiment, lead wire support device 40 is fixed to the inner wall on the floor side of tank 20. Lead wire support device 40 is configured to support lead wire 30 drawn out from winding 10 toward the floor of tank 20.

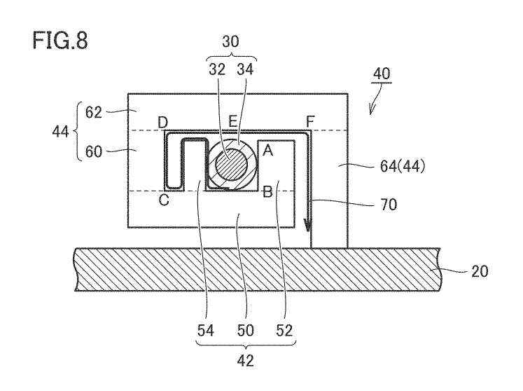

FIG. 8 is a sectional view of the stationary induction apparatus of FIG. 7, taken along the line VIII-VIII in a direction of arrows. The configuration of lead wire support device 40 according to the second embodiment is described using FIG. 8.

Referring to FIG. 8, a basic configuration of lead wire support device 40 according to the second embodiment is the same as that of lead wire support device 40 described in the first embodiment. The shape of fixing portion 44 is different than that of the first embodiment.

Specifically, in fixing portion 44, first member 60 is disposed to stand from second member 62 toward the floor of tank 20. Third member 64 is disposed to stand from second member 62 toward the floor of tank 20.

As shown in FIG. 8, when a creeping discharge occurs between lead wire 30 and tank 20, the creeping discharge progresses from lead wire 30 toward tank 20 on creepage path 70 formed on the surface of lead wire support device 40.

As in lead wire support device 40 according to the first embodiment, in lead wire support device 40 according to the second embodiment, creepage path 70 from lead wire 30 to the inner wall of tank 20 is provided with a section for hindering the progress of a creeping discharge. This section is configured such that the direction of an electric field is opposite to the direction of progress of a creeping discharge.

In the example of FIG. 8, this section is implemented by second member 62 of fixing portion 44. More particularly, as in FIGS. 4 and 5, the plurality of points A to F are set on creepage path 70 in FIG. 8. Points A to F are at successively increasing creepage distances from lead wire 30. Furthermore, points A to F are at nonuniform spatial distances from lead wire 30. Thus, the potentials at points A to F are also nonuniform. More particularly, point A, point B and point E are at shorter spatial distances from lead wire 30 than point C, point D and point F. Thus, the potentials at point A, point B and point E are higher than the potentials at point C, point D and point F.

In FIG. 8, too, looking at point D and point E, point E is at a longer creepage distance from lead wire 30 than point D. On the other hand, point E is at a shorter spatial distance from lead wire 30 than point D. Thus, the potential at point E is higher than the potential at point D. Accordingly, in the section from point D to point E, the potential increases with increase in the creepage distance from lead wire 30. In the section from point D to point E, therefore, a creeping discharge is forced to travel from a low potential area to a high potential area, so that the progress of the creeping discharge is hindered. That is, the section from point D to point E implements a section for hindering the progress of a creeping discharge. As a result, the lead wire support device according to the second embodiment can provide a function and effect similar to those of the lead wire support device according to the first embodiment.

In lead wire support device 40 according to each of the first and second embodiments, point D on the creepage path from lead wire 30 to the inner wall of tank 20 corresponds to a “first point,” and point E corresponds to a “second point.” It is preferable that the spatial distance from lead wire 30 to the second point be shorter than the spatial distance from lead wire 30 to the first point. Accordingly, a potential at the second point will be inevitably higher than a potential at the first point, so that a section in which an electric field is generated in a direction opposite to the direction of progress of a creeping discharge can be formed between the first point and the second point.

As described above, the gist of the present invention is to form, in the creepage path in lead wire support device 40, a section in which an electric field is generated in a direction opposite to the direction of progress of a creeping discharge. Therefore, the shape of lead wire support device 40 and the positions of the first and second points are not limited to those illustrated in the first and second embodiments as long as they do not depart from the gist of the present invention.

### Third Embodiment

As was illustrated in the first and second embodiments described above, lead wire support device 40 supports lead wire 30 fixed at a plurality of locations of the inner wall of tank 20. A preferred arrangement structure of a plurality of lead wire support devices 40 is described in a third embodiment.

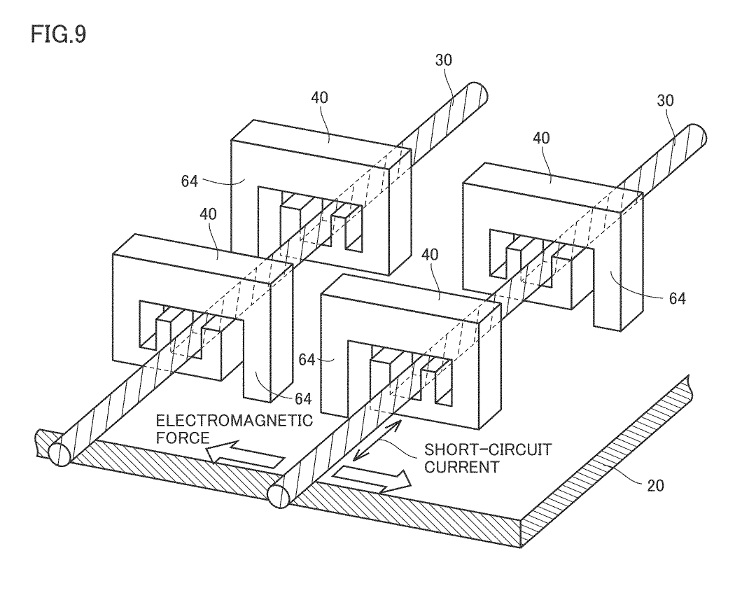

FIG. 9 is an external perspective view illustrating an arrangement structure of lead wire support devices 40 according to the third embodiment. Each of lead wire support devices 40 according to the third embodiment is the same as lead wire support device 40 according to the second embodiment (FIG. 8).

Referring to FIG. 9, a plurality of lead wires 30 are provided parallel to each other. On the inner wall of tank 20, a plurality of lead wire support devices 40 are aligned for each lead wire 30 along a direction in which lead wire 30 extends.

When a short-circuit current flows in lead wire 30 due to a system failure or the like, an electromagnetic force acts on lead wire 30 as shown in FIG. 9. The direction and magnitude of the electromagnetic force are determined in accordance with the direction and magnitude of the short-circuit current. When a large short-circuit current flows, a large electromagnetic force is generated in lead wire 30, causing stress to act on lead wire support device 40. As lead wire support device 40 receives the stress continuously or repeatedly, the mechanical strength of lead wire support device 40 is reduced, which may result in breakage.

As shown in FIG. 8, when lead wire support device 40 is viewed in the direction in which lead wire 30 extends, third member 64 serving as a base is located on one side (right side in the example of FIG. 8) in a horizontal direction relative to lead wire 30. Thus, with the weight of lead wire 30 added to sandwiching and holding portion 42, third member 64 is structured such that it tends to bend toward the other side (left side in the example of FIG. 8) in the horizontal direction. Accordingly, in lead wire support device 40, the strength against stress toward this other side in the horizontal direction is lower than the strength against stress toward the one side in the horizontal direction. Thus, when stress is applied in a direction toward the other side in the horizontal direction in response to an electromagnetic force of lead wire 30, lead wire support device 40 may be broken.

In this manner, when viewed in the direction in which lead wire 30 extends, the mechanical strength of lead wire support device 40 against stress acting in the horizontal direction varies with the direction of the stress. In the third embodiment, as shown in FIG. 9, first and second lead wire support devices 40 adjacent to each other are disposed such that their respective bases (which correspond to third members 64) face each other with lead wire 30 interposed therebetween, when viewed in the direction in which lead wire 30 extends.

Accordingly, in a situation where stress toward the other side in the horizontal direction is acting on first lead wire support device 40 in response to an electromagnetic force of lead wire 30, for example, stress toward the one side in the horizontal direction is acting on second lead wire support device 40. In such a situation, first lead wire support device 40 has lower mechanical strength against the stress, whereas second lead wire support device 40 has higher strength against the stress. Thus, second lead wire support device 40 can bear part of the stress applied to first lead wire support device 40. As a result, the stress on first lead wire support device 40 can be substantially relieved, so that the breakage can be avoided.

The same applies to a situation where stress toward the other side in the horizontal direction is acting on second lead wire support device 40, and stress toward the one side in the horizontal direction is acting on first lead wire support device 40.

As described above, in accordance with the stationary induction apparatus according to the third embodiment, the plurality of lead wire support devices 40 aligned along the direction in which lead wire 30 extends can support the lead wire whether the stress acts toward one side or the other side in the horizontal direction when viewed in the direction in which the lead wire extends.

It should be understood that the embodiments disclosed herein are illustrative and non-restrictive in every respect. The scope of the present invention is defined by the terms of the claims, rather than the description above, and is intended to include any modifications within the meaning and scope equivalent to the terms of the claims.

### REFERENCE SIGNS LIST

5 core; 10 winding; 12 first end frame; 14 second end frame; 16 first support plate; 18 second support plate; 20 tank; 30 lead wire; 32 conductor; 34 insulating paper; 40 lead wire support device; 42 sandwiching and holding portion; 44 fixing portion; 50 base portion; 52, 54 protrusion; 60 first member; 62 second member; 64 third member; 70 creepage path; 100 stationary induction apparatus.

1. A stationary induction apparatus comprising:
a core;
a winding wound around the core;
a tank containing the core and the winding; and
a lead wire support device made of an insulator and supporting a lead wire drawn out from the winding,
the lead wire support device being fixed to an inner wall of the tank,
a creepage path from the lead wire to the inner wall including a first point at which a creepage distance from the lead wire is a first distance, and a second point at which the creepage distance from the lead wire is a second distance longer than the first distance,
a potential at the second point being higher than a potential at the first point.

2. The stationary induction apparatus according to claim 1, wherein
in a section from the first point to the second point of the creepage path, potential increases with increase in the creepage distance from the lead wire.

3. The stationary induction apparatus according to claim 1, wherein
a spatial distance from the lead wire to the second point is shorter than a spatial distance from the lead wire to the first point.

4-6. (canceled)

7. The stationary induction apparatus according to claim 2, wherein
a spatial distance from the lead wire to the second point is shorter than a spatial distance from the lead wire to the first point.

8. The stationary induction apparatus according to claim 1, wherein the lead wire support device includes
a sandwiching and holding portion configured to sandwich and hold the lead wire, and
a fixing portion configured to fix the sandwiching and holding portion to the inner wall, and the first point and the second point are located at the fixing portion.

9. The stationary induction apparatus according to claim 2, wherein the lead wire support device includes
a sandwiching and holding portion configured to sandwich and hold the lead wire, and
a fixing portion configured to fix the sandwiching and holding portion to the inner wall, and the first point and the second point are located at the fixing portion.

10. The stationary induction apparatus according to claim 3, wherein the lead wire support device includes
a sandwiching and holding portion configured to sandwich and hold the lead wire, and
a fixing portion configured to fix the sandwiching and holding portion to the inner wall, and the first point and the second point are located at the fixing portion.

11. The stationary induction apparatus according to claim 7, wherein the lead wire support device includes
a sandwiching and holding portion configured to sandwich and hold the lead wire, and
a fixing portion configured to fix the sandwiching and holding portion to the inner wall, and the first point and the second point are located at the fixing portion.

12. The stationary induction apparatus according to claim 1, wherein
a plurality of the lead wire support devices are aligned on the inner wall along a direction in which the lead wire extends, and
first and second lead wire support devices adjacent to each other are disposed such that their respective bases face each other with the lead wire interposed therebetween, when viewed in the extension direction.

13. A lead wire support device for fixing a lead wire of a winding contained in a tank to an inner wall of the tank,
a creepage path from the lead wire to the inner wall including a first point at which a creepage distance from the lead wire is a first distance, and a second point at which the creepage distance from the lead wire is a second distance longer than the first distance,
a potential at the second point being higher than a potential at the first point.
